(19) United States
(12) Patent Application Publication
(10) Pub. No.: US 2014/0024270 A1
(43) Pub. Date: Jan. 23, 2014

(54) CONNECTING DEVICE USING SHAPE MEMORY ALLOY

(71) Applicant: KOREA INSTITUTE OF SCIENCE AND TECHNOLOGY, Seoul (KR)

(72) Inventor: Kwang Koo JEE, Seoul (KR)

(73) Assignee: KOREA INSTITUTE OF SCIENCE AND TECHNOLOGY, Seoul (KR)

(21) Appl. No.: 13/683,289

(22) Filed: Nov. 21, 2012

(30) Foreign Application Priority Data
Jul. 23, 2012 (KR) 10-2012-0080254

(51) Int. Cl. F16K 31/00

(52) U.S. Cl. CPC F16K 31/002
USPC 439/887

(57) ABSTRACT

A connecting device using a shape memory alloy (SMA). The connecting device uses an SMA, which firmly connects female member with male member inserted into the female member, in which a wire member formed of an SMA material is wound a plurality of times in a spiral shape, a hollow into which the female member is inserted is formed in a center portion of the spiral shape, and when the male member being inserted into the female member, the wire member presses against an outer circumferential surface of the female member to prevent the male member from being separated from the female member. According to the present invention, a connection is possible in a high-temperature phase corresponding to room temperature as well as in a low-temperature phase, and an allowable tolerance, which is a difference between a diameter of a hollow and an outer diameter of a female member, increases.

### CROSS-REFERENCE TO RELATED PATENT APPLICATION

This application claims the benefit of Korean Patent Application No. 10-2012-0080254, filed on Jul. 23, 2012, in the Korean Intellectual Property Office, the disclosure of which is incorporated herein in its entirety by reference.

### BACKGROUND OF THE INVENTION

1. Field of the Invention

The present invention relates to a connecting device using a shape memory alloy, and more particularly, to a connecting device which enables connection at a high temperature which is room temperature and an increase in an allowable tolerance.

2. Description of the Related Art

A shape memory alloy (SMA) has a so-called shape memory effect in which when the alloy that deformed in a low-temperature phase (martensitic phase) is heated to a high-temperature phase (austenite phase), the alloy returns to its original shape.

Such a shape memory effect is applied in various fields such as the medical industry, the manufacturing industry, and so forth, one of which is the connecting field for connecting two members. FIG. 1 shows an example of a conventional connecting device 1.

The conventional connecting device 1 firmly connects a female member 2 having an insertion hole 4 with a male member 3 inserted into the insertion hole 4 of the female member 2. The conventional connecting device 1 may be an SMA tube having a hollow 5 into which the female member 2 is inserted. Herein, the female member 2 and the male member 3 are respectively a socket and a pin that are generally used in an electric connector.

The conventional connecting device 1 operates such that in a phase at a high temperature which is room temperature, that is, in the austenite phase, an inner diameter D4 of the hollow 5 contracts and in a phase at a low temperature which is lower than room temperature, that is, in the martensitic phase, the inner diameter D4 of the hollow 5 expands. Thus, as shown in FIG. 2, at room temperature, the male member 3 is firmly connected to the female member 2 by a contractile force of the connecting device 1, and after the temperature is cooled to the low temperature, the contractile force of the connecting device 1 is removed so that the male member 3 easily separates from the female member 2.

Manufacturing and operating principles of the connecting device 1 using the SMA tube will be described in detail.

First, the SMA tube is manufactured to have the inner space D4, which is smaller than an outer diameter D2 of the female member 2 by about 7%, and then the manufactured SMA tube is thermally treated. The shape of the SMA tube after being thermally treated is the original shape (the contracted shape in the low-temperature phase). Herein, the SMA tube may be in the low-temperature phase (martensitic phase) at minus 10 degrees (−10° C.) or lower and be in the high-temperature phase (austenite phase) at room temperature.

When the thermally treated SMA tube is cooled to about −10° C. to enter the low-temperature phase, the inner diameter D4 of the SMA tube expands by about 7% or more to be larger than the outer diameter D2 of the female member 2, such that a tolerance between the inner diameter D4 of the SMA tube and the outer diameter D2 of the female member 2 (a difference therebetween in the low-temperature phase and in the high-temperature phase) needs to be considered well.

When the SMA tube that expanded in the low-temperature phase is maintained at the low temperature, the female member 2 is inserted into the hollow 5. In this state, attention needs to be paid because if the temperature of the SMA tube increases and thus the SMA tube enters the high-temperature phase, the SMA tube contracts due to the shape memory effect.

If the SMA tube enters the high-temperature phase as the temperature increases to room temperature, the SMA tube contracts to return to the original shape (the contracted shape) such that the female member 2 and the male member 3 are firmly connected with each other by the contractile force of the SMA tube.

On the other hand, when the temperature is lowered using a spray-type cooling gas, the SMA tube enters the low-temperature phase and almost loses the contractile force, and as the elastically contracted female member 2 expands, the SMA tube expands together, such that the male member 3 may easily separate from the female member 2.

As such, the conventional connecting device 1 enables connection and separation within a short time by using a spray-type cooling gas, unlike a general connecting device which requires a complex device for locking and unlocking for connection and separation and needs much time and effort.

However, the conventional connecting device 1 is expensive and may not be easily obtained with a desired size because it has not been a long since the commercial manufacturing of the SMA tube started. In particular, because the outer diameter and the inner diameter of the SMA tube have to be manufactured with accurate sizes, they may be produced on demand and thus a long manufacturing time may be required.

Moreover, it is difficult to expand the conventional connecting device 1 with a precise dimension when the SMA tube is cooled to the low temperature, and it is also difficult to maintain the temperature constant until the expanded SMA tube is inserted into the female member 2. In particular, if a little bend or unevenness occurs in the SMA tube when the SMA tube expands, insertion into the female member 2 is impossible, thus requiring a precise operation.

Furthermore, in the conventional connecting device 1, the SMA tube, when cooled to room temperature, expands with an accurate dimension and the expanded SMA tube is inserted into the female member 2, thus requiring a high level of dimension precision of the SMA tube. Therefore, a tolerance between the inner diameter D4 of the SMA tube and the outer diameter D2 of the female member 2 and a tolerance between an outer diameter D3 of the male member 3 and an inner diameter D1 of the female member 2 have to be strictly considered.

Due to the foregoing problems, a connection using an SMA is used for special purposes such as military parts and an application thereof to general industrial goods is limited.

### SUMMARY OF THE INVENTION

The present invention provides a connecting device which enables connection in a phase at a high temperature which is room temperature and an increase in an allowable tolerance.

According to an aspect of the present invention, there is provided a connecting device using a shape memory alloy (SMA), which firmly connects a female member having an insertion hole with a male member inserted into the insertion hole of the female member, in which a wire member formed of an SMA material is wound a plurality of times in a spiral shape, a hollow into which the female member is inserted is formed in a center portion of the spiral shape, and when the male member being inserted into the insertion hole of the female member, the wire member presses against an outer circumferential surface of the female member to prevent the male member from being separated from the insertion hole of the female member.

The wire member may be an SMA which contracts in a high-temperature phase and is extended in a low-temperature phase.

When the wire member is in the high-temperature phase, the male member may not be separable from the insertion hole of the female member, and when the wire member is in the low-temperature phase, the male member may be separable from the insertion hole of the female member.

When the wire member is in the high-temperature phase, the female member may be insertable into the hollow.

An outer circumferential surface of the female member may be in a cylindrical shape, and the spiral shape may be a circular coil shape corresponding to the shape of the outer circumferential surface of the female member.

A cross section of the wire member may be in a square shape.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view showing an example of a conventional connecting device;

FIG. 2 is a diagram showing a state in which a female member and a male member are connected with each other using the connecting device shown in FIG. 1;

FIG. 3 is a perspective view showing a connecting device using a shape memory alloy (SMA) according to an embodiment of the present invention;

FIG. 4 is a diagram showing a state in which a female member and a male member are connected with each other using the connecting device shown in FIG. 3;

FIG. 5 is a cross-sectional view of the connecting device shown in FIG. 4, taken along a long V-V′; and

FIG. 6 is a cross-sectional view showing a wire member having a square cross section.

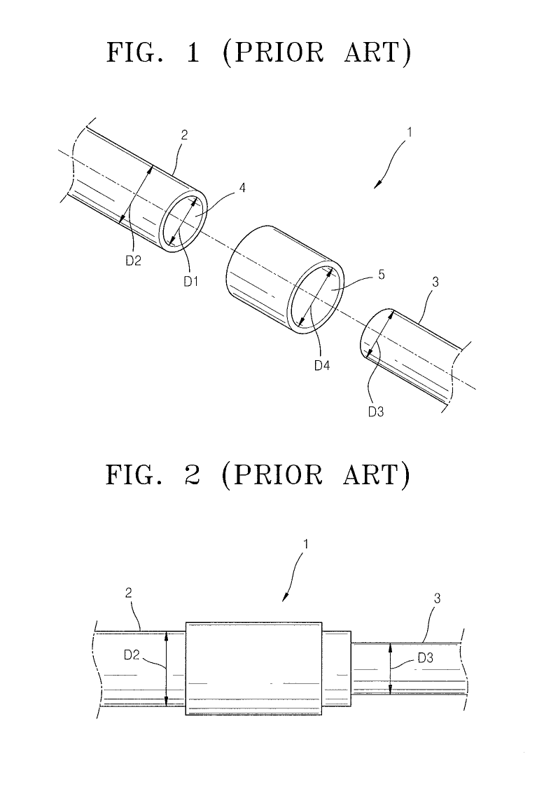

### DETAILED DESCRIPTION OF THE INVENTION

Hereinafter, an embodiment of the present invention will be described in detail with reference to the accompanying drawings.

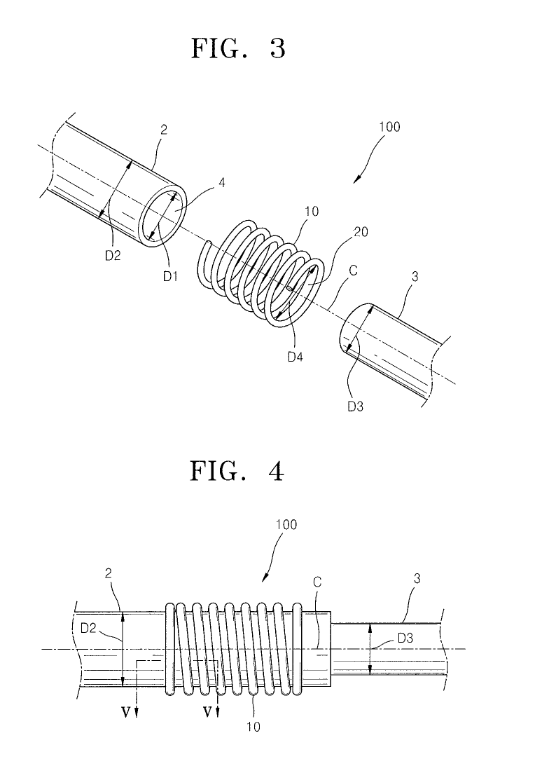

FIG. 3 is a perspective view showing a connecting device 100 using a shape memory alloy (SMA) according to an embodiment of the present invention, and FIG. 4 is a diagram showing a state in which a female member 2 and a male member 3 are connected with each other using the connecting device 100 shown in FIG. 3.

Referring to FIGS. 3 and 4, the connecting device 100 using an SMA according to an embodiment of the present invention firmly connects the female member 2 having an insertion hole 4 with the male member 3 inserted into the insertion hole 4 of the female member 2. The connecting device 100 using an SMA may include a wire member 10 and a hollow 20. Herein, the female member 2 and the male member 3 may respectively have socket and pin structures generally used in an electric connector.

The female member 2 is a cylindrical pipe member which has an outer circumferential surface and an inner circumferential surface in a circular shape and extends along a central axis C. The male member 3 is a rod member which has a cross section in a circular shape and extends along the central axis C.

So that the male member 3 inserts into the insertion hole 4 of the female member 2, an inner diameter D1 of the female member 2 may be equal to or larger than an outer diameter D3 of the male member 3.

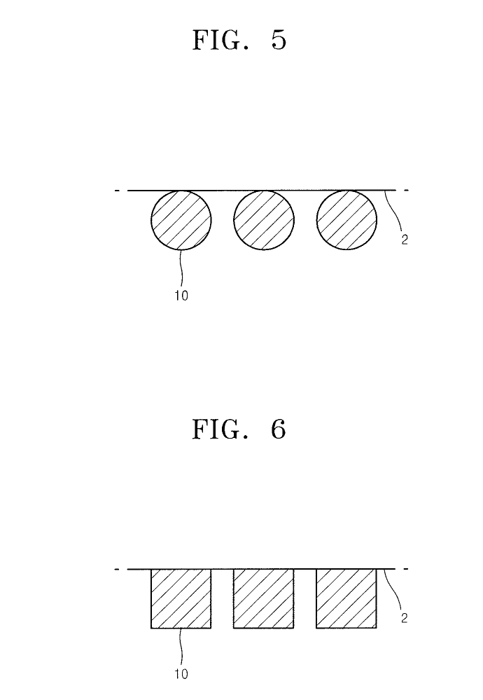

The wire member 10 is a wire member formed of an SMA material. The wire member 10 is a circular coil spring member which has a circular-shape cross section, as shown in FIG. 5, and is spirally wound a plurality of times around the central axis C, as shown in FIG. 3.

The wire member 10 maintains its circular coil shape, as shown in FIG. 3, in a low-temperature phase (martensitic phase) and a high-temperature phase (austenite phase). Herein, the spiral shape of the wire member 10 is a circular coil shape corresponding to the shape of the outer circumferential surface of the female member 2 to closely contact the outer circumferential surface of the female member 2.

The wire member 10 may be elastically deformed with high elasticity in the high-temperature phase and the low-temperature phase and contracts in the high-temperature phase corresponding to room temperature and extends in the low-temperature phase like a general SMA. In the current embodiment, the wire member 10 is manufactured with a Ni—Ti-based SMA.

The hollow 20 is a formed by the spiral shape of the wire member 10, and extends along the central axis C of the spiral shape to allow the female member 2 to insert into the hollow 20.

In the current embodiment, a diameter D4 of the hollow 20 is smaller than the outer diameter D2 of the female member 2 in the high-temperature phase and the low-temperature phase.

The diameter D4 of the hollow 20 has a size which prevents the male member 3 from being separated from the insertion hole 4 of the female member 2, even if the male member 3 is pulled with a strong external force of a predetermined size when the wire member 10 is in the high-temperature phase.

The diameter D4 of the hollow 20 has a size which allows the male member 3 to be separated from the insertion hole 4 of the female member 2 if the male member 3 is pulled with a weak external force of a predetermined size when the wire member 10 is in the low-temperature phase.

Hereinafter, an example of a method of using the above-described connecting device 100 using the SMA will be described.

First, in the high-temperature phase corresponding to room temperature, the female member 2 and the male member 3 are connected using the connecting device 100 in a manner described below.

In a state where the male member 2 is inserted into the hollow 20, the male member 3 is inserted into the insertion hole 4 of the female member 2 and an end portion of the wire member 10 contacts an end portion of the female member 2.

Next, the wire member 10 in the high-temperature phase is slowly rotated around the central axis C, such that the wire member 10 gradually surrounds the outer circumferential surface of the female member 2. As the wire member 10 is continuously rotated, the female member 2 is completely inserted into the hollow 20 in the high-temperature phase.

While the diameter D4 of the hollow 20 is smaller than the outer diameter D2 of the female member 2 in the high-temperature phase, the wire member 10 is bent in a radial direction of the female member 2, thus surrounding the outer circumferential surface of the female member 2.

In this way, once the female member 2 is completely inserted into the hollow 20, the wire member 10 presses against the outer circumferential surface of the female member 2 and by the pressurizing force or elastic force, the male member 3 is firmly connected with the female member 2 without being separated from the insertion hole 4 of the female member 2.

Second, in the low-temperature phase, the female member 2 is connected with the male member 3 by using the connecting device 100 in a manner described below.

First, in a state where the male member 3 is inserted into the hollow 20, the male member 3 is inserted into the insertion hole 4 of the female member 2 and an end portion of the wire member 10 contacts an end portion of the female member 2.

Next, once the temperature of the wire member 10 is lowered by spraying a spray-type cooling gas, the wire member 10 enters the low-temperature phase and the diameter D4 of the hollow 20 becomes larger than in the high-temperature phase. Thus, under a condition of the connecting device 100 having the same shape and size, it becomes easier to insert the wire member 10 into the female member 2 in the low-temperature phase than in the high-temperature phase.

The wire member 10 in the low-temperature phase is slowly rotated around the central axis C, such that the wire member 10 gradually surrounds the outer circumferential surface of the female member 2. As the wire member 10 is continuously rotated, the female member 2 is completely inserted into the hollow 20 in the low-temperature phase.

In this state, the diameter D4 of the hollow 20 is smaller than the outer diameter D2 of the female member 2 in the low-temperature phase, but the wire member 10 is bent in a radial direction of the female member 2, thus surrounding the outer circumferential surface of the female member 2.

After the female member 2 is completely inserted into the hollow 20, the temperature increases to room temperature corresponding to the high-temperature phase and the wire member 10 presses against the outer circumferential surface of the female member 2 more than in the low-temperature phase. By the pressurizing force or elastic force, the male member 3 is firmly connected with the female member 2 without being separated from the insertion hole 4 of the female member 2.

The second connecting method may be useful when insertion of the wire member 10 in the high-temperature phase into the female member 2 is difficult to do because the diameter of the wire member 10 is relatively large.

The female member 2 and the male member 3 may be separated from each other in a manner described below.

In the room-temperature phase in which the female member 2 and the male member 3 are connected with each other using the above-described first or second method, a spray-type cooling gas is sprayed to lower the temperature of the wire member 10. Then, the wire member 10 enters the low-temperature phase such that the diameter D4 of the hollow 20 becomes larger than in the high-temperature phase.

As such, once the wire member 10 is slowly rotated around the central axis C and is pulled when the wire member 10 is in the low-temperature phase, the wire member 10 gradually leaves the outer circumferential surface of the female member 2. As the wire member 10 is continuously rotated, the wire member 10 may be completely separated from the female member 2 in the low-temperature phase.

After the connecting device 100 is separated, the male member 3 is separated from the female member 2 by pulling the male member 3, thus completing the separation operation.

In the above-described connecting device 100, the wire member 10 formed of an SMA material is wound in a spiral shape a plurality of times, and the hollow 20 into which the female member 2 is inserted is formed in a center portion of the spiral shape, such that the wire member 10 may be bent. Thus, a connection is possible even in the high-temperature phase corresponding to room temperature and an allowable tolerance, which is a difference between the diameter D4 of the hollow 20 and the outer diameter D2 of the female member 2, increases.

The connecting device 100 enables connection in the high-temperature phase corresponding to room temperature, such that unlike the conventional SMA tube, it is not necessary to continuously maintain the low-temperature phase for a predetermined time after expanding the SMA tube, thereby making it possible to easily perform the connection operation.

The connecting device 100 includes the wire member 10 in a wire shape, such that the material cost thereof is lowered by about 1/10 than the conventional SMA tube and thus the wire member 10 may be easily supplied. Moreover, since the wire member 10 is manufactured by spiral winding, the diameter D4 of the hollow 20 may be easily adjusted, facilitating processing of the connecting device 100.

While the diameter D4 of the hollow 20 is smaller than the outer diameter D2 of the female member 2 in the high-temperature phase and the low-temperature phase in the current embodiment, it may be larger than the outer diameter D2 of the female member 2 in the low-temperature phase.

The female member 2 and the male member 3 respectively have socket and pin structures generally used in an electric connector in the current embodiment, but they may also be used as pipe-type members for piping.

While the cross section of the wire member 10 is in a circular shape in the current embodiment, it may also have a square shape as shown in FIG. 6. In this case, a cross-sectional second moment of area of the wire member 10 may be manufactured larger to provide a larger pressurizing force than with the circular-shape cross section.

In the current embodiment, the wire member 10 has a circular coil shape corresponding to the shape of the outer circumferential surface of the female member 2. However, if the outer circumferential surface of the female member 2 has a hexagonal cross-section, the wire member 10 may also have a hexagonal coil shape to closely contact the outer circumferential surface of the female member 2 having the hexagonal cross section.

According to the present invention, a wire member formed of an SMA material is wound in a spiral shape a plurality of times, and a hollow into which a female member is inserted is formed in a center portion of the spiral shape, such that connection is possible in the high-temperature phase corresponding to room temperature and an allowable tolerance increases.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A connecting device using a shape memory alloy (SMA), which firmly connects a female member having an insertion hole with a male member inserted into the insertion hole of the female member,
wherein a wire member formed of an SMA material is wound a plurality of times in a spiral shape,
a hollow into which the female member is inserted is formed in a center portion of the spiral shape, and
when the male member being inserted into the insertion hole of the female member, the wire member presses against an outer circumferential surface of the female member to prevent the male member from being separated from the insertion hole of the female member.

2. The connecting device of claim 1, wherein the wire member is an SMA which contracts in a high-temperature phase and extends in a low-temperature phase.

3. The connecting device of claim 2, wherein when the wire member is in the high-temperature phase, the male member is not separable from the insertion hole of the female member, and
when the wire member is in the low-temperature phase, the male member is separable from the insertion hole of the female member.

4. The connecting device of claim 2, wherein when the wire member is in the high-temperature phase, the female member is insertable into the hollow.

5. The connecting device of claim 1, wherein an outer circumferential surface of the female member is in a cylindrical shape, and
the spiral shape is a circular coil shape corresponding to the shape of the outer circumferential surface of the female member.

6. The connecting device of claim 1, wherein a cross section of the wire member is in a square shape.
